(19) United States
(12) Patent Application Publication
(10) Pub. No.: US 2008/0241401 A1
(43) Pub. Date: Oct. 2, 2008

(54) METHOD OF MONITORING ELECTROLESS PLATING CHEMISTRY

(76) Inventors: Hok-kin Choi, San Jose, CA (US); Yong-mei Wu, San Jose, CA (US); Vani Thirumaia, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/692,907

(22) Filed: Mar. 28, 2007

(51) Int. Cl. B05D 3/10

(52) U.S. Cl. 427/304; 118/407

(57) ABSTRACT

Methods and associated structures of forming a microelectronic device are described. Those methods may include an electroless plating process, that may comprise an electroless plating bath, wherein the electroless plating bath comprises a stabilizer and a suppressor, separating the stabilizer and the suppressor by using a HPLC, determining the concentration of a UV/VIS detectable one of the stabilizer and the suppressor by using a UV/VIS, and determining the concentration of an ELSD detectable one of the suppressor and the stabilizer by using an ELSD.

### BACKGROUND OF THE INVENTION

An electroless plating process may be used during formation of various microelectronic structures. In some cases, various chemical baths may be employed (such as a sensitizer bath, a catalytic bath and an electroless plating bath) to form conductive materials in vias and/or trenches of a Damascene structure, for example. Efficiently monitoring and optimizing the chemical constituents in the chemical baths used during processing may greatly affect throughput, cost and yield of manufacturing.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1a represents structures according to embodiments of the present invention.

FIGS. 1b, 1c, 1e, 1f represents flow charts according to embodiments of the present invention.

FIGS. 1d represents a graph according to an embodiment of the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Methods and associated structures of forming a microelectronic structure are described. Those methods may include an electroless plating process comprising an electroless plating, wherein the electroless bath comprises a stabilizer and a suppressor, separating the stabilizer and the suppressor by using a HPLC, determining the concentration of a UV/VIS detectable one of the stabilizer and the suppressor by using a UV/VIS, and determining the concentration of an ELSD detectable one of the suppressor and the stabilizer by using an ELSD. Methods of the present invention enable monitoring of the electroless plating process chemicals to greatly increase throughput and lower manufacturing costs.

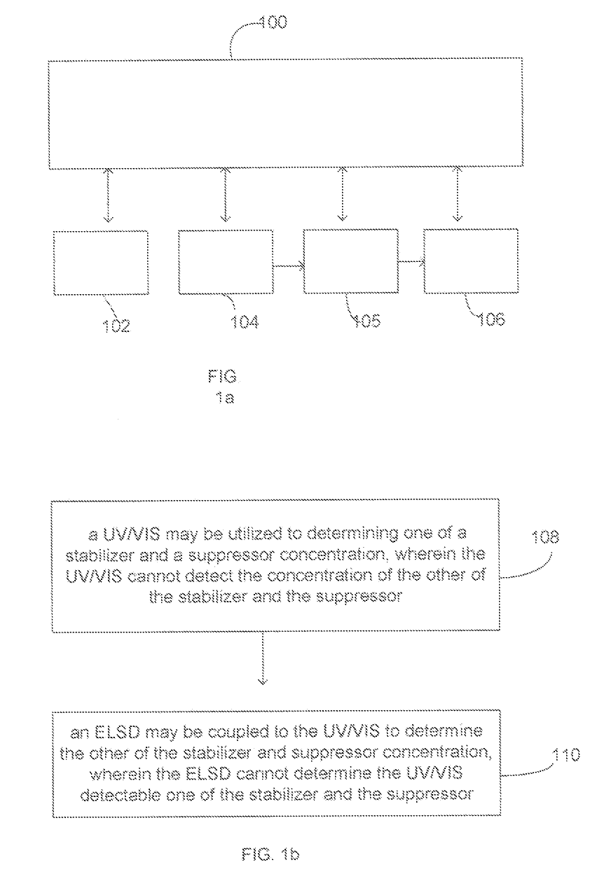

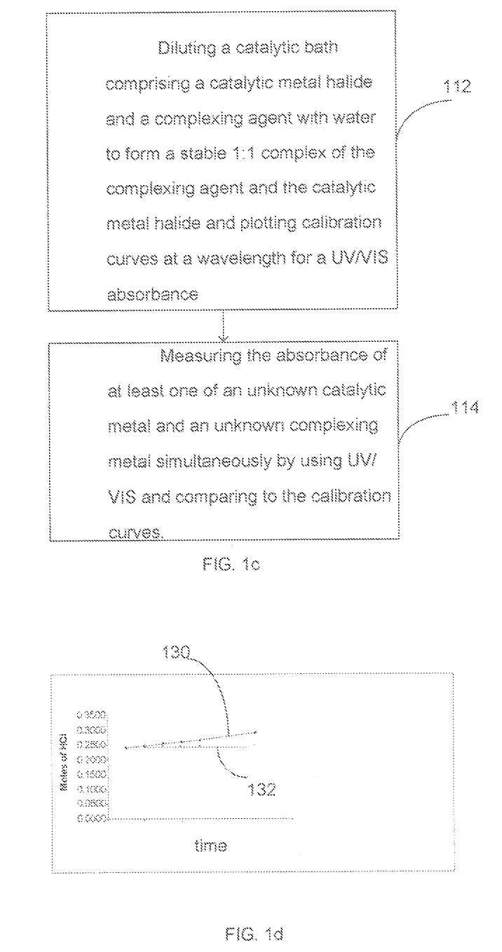

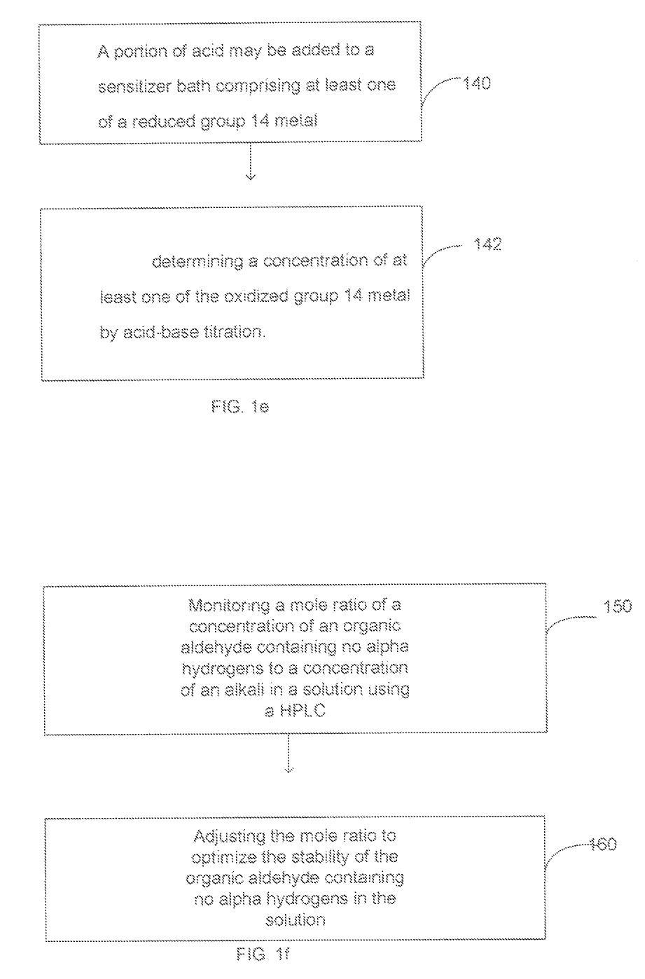

FIGS. 1a-1f illustrate embodiments of methods of monitoring various chemicals that may be present in various baths associated with an electroless plating process 100, such as a copper electroless plating process, for example. FIG. 1a depicts the electroless plating process 100 that may comprise a reducing agent stock solution 102, a catalytic bath 104, a sensitizer bath 105 and an electroless plating bath 106. The electroless plating bath 106 may comprise an organic stabilizer additive which may comprise, for example, pyridyl derivatives, and an organic suppressor additive, which may comprise derivatives of polyethylene glycol (PEG), for example.

Monitoring/characterizing the stabilizer and the suppressor additives in a metal (for example, copper, cobalt and nickel) electroless plating bath and its related solutions allows for maintaining reproducible and accurate concentrations of the additives within the solution. Hence yield on direct via/trench superfilling of damascene structures, for example, can be maximized and defect formations can be minimized through monitoring of the plating solution. Any solution which contains a number of various organic ingredients that are only UV/VIS active but ELSD inactive (eg. pyridyl derivatives) while others that are only ELSD active but UV/VIS inactive (eg. derivatives of PEG) may be monitored simultaneously employing various embodiments of the present invention.

A multiple-detector assay may be used to monitor the various organic additives in the electroless plating bath for yield (on direct via/trench superfilling, for example) improvement and defect minimization. The concentration of the organic stabilizer and the organic suppressor additives may be determined through the application of liquid chromatography (for example, HPLC) integrated and coupled with a UV/VIS that may be coupled with an ELSD tool, and a well-adjusted eluent condition. The HPLC, UV/VIS and ELSD tools may be coupled according to the particular application, and may be coupled either in parallel or in series with each other in some embodiments. Such a multiple-detector setup enables characterization of key organic stabilizer and suppressor additives simultaneously in a metal electroless plating bath and its related solutions.

In one embodiment, the eluent condition for the chromatographic analysis may be specifically developed and optimized for the UV/VIS and ELSD detectors to function properly at the same time without affecting their baseline stability. Usually eluent conditions which fit UV/VIS detectors well do not work for ELSD detectors, and vise versa. In one embodiment, a high performance liquid chromatography system (HPLC) may be utilized to separate components from each other. In one embodiment, an analytical column with a resin-based packing material coated by a poly styrene-divinylbenzene stationary phase may be employed.

In one embodiment, an ELSD may be used with a nebulizer gas flow and a rate of evaporation being optimized to achieve the best light scattering signals for the suppressor and its byproducts simultaneously. An optimized eluent mixture of distilled water, low boiling point organic solvent, and low boiling point organic acid to achieve the best resolution of the mixture of the organic stabilizer and the suppressor additives and their byproducts from the high copper sulfate and strong alkali matrix that may be present in a copper electroless plating process, for example, without affecting the performance (eg. baseline) of the UV/VIS and ELSD detectors.

Both detectors can work at the same time together. Optimization of the low boiling point organic solvent and acid are very critical, otherwise suitable sizes of particles may not be formed from the additives in the solution for light scattering characterization. Peak areas of both signals with unknown concentrations may be integrated separately and may be compared to calibration curves respectively. In one embodiment, the HPLC may be directly coupled to the UV/VIS and the ELSD, and may separate the stabilizer from the suppressor utilizing an eluent that is optimized for their separation, and wherein the HPLC feeds the separated stabilizer and suppressor to the corresponding one of the UV/VIS and ELSD, depending upon their detectability by the particular tool.

In one embodiment, a UV/VIS may be utilized to determining one of a stabilizer and a suppressor concentration, wherein the UV/VIS cannot detect the concentration of the other of the stabilizer and the suppressor (FIG. 1b, step 108). At step 110, an ELSD may be coupled to the UV/VIS to determine the other of the stabilizer and suppressor concentration, wherein the ELSD cannot determine the UV/VIS detectable one of the stabilizer and the suppressor. Thus, the concentration of the stabilizer and the suppressor may be determined in as little as about 15 minutes, which aids in throughput and cost reduction of the electroless plating process.

The electroless plating process 100 may further comprise a catalytic bath 104 (FIG. 1a). In one embodiment, the catalytic bath 104 may comprise organic/weak acids, inorganic/strong acids, catalytic metals and complexing agents/aminopolycarboxylic acid. The complexing agent/aminopolycarboxylic, (for example, ethylenediaminetetraacetic acid (EDTA)), usually behaves like both a strong and weak acid, hence the assay determination of the complexing agent/aminopolycarboxylic acid may be affected by the other two organic/weak and inorganic/strong acids in the same solution if conventional acid/base titration methods are being used.

In one embodiment, a UV/VIS monitor for the determination of the concentrations of the catalytic metal and the complexing agent (complexed and free) may be performed in order to minimize defect formations in the catalytic step of a copper electroless plating process, for example. In one embodiment, concentrations of group VIII transition metals, such as nickel, palladium and platinum and concentrations of any complexing agents/aminopolycarboxylic acids such as EDTA, both complexed and free, may be separately and simultaneously determined in any solution (eg. the catalyst bath of a copper electroless plating process) without being affected by the interference from an organic/weak (eg. acetic acid, HAc) and inorganic/strong (eg. hydrochloric acid, HCl) acids.

In one embodiment, the stability and shelf-life of the catalytic metals and the complexing agents/aminopolycarboxylic acids may be determined simultaneously in a catalyst bath of the copper electroless plating process and any related solutions that may be used in semiconductor manufacturing. The methods of the present embodiment can be used as a quality control methodology for an incoming catalyst bath, and also to monitor a stock solution.

In one embodiment, a stable complex may be formed between the catalytic metal and the complexing agent/aminopolycarboxylic acid with a well-adjusted distilled water dilution, which may be optimized according to the particular application. The concentration of the stable complex may then be determined through the use of simple UV/VIS measurements. The absorbance of the complex may be compared to catalytic metal and complexing agent/aminopolycarboxylic acid calibration curves that may be generated separately. Hence, the catalytic metal and the agent/aminopolycarboxylic acid (both complexed and free) can be determined separately. No time consuming extraction and/or separation techniques are required.

In one embodiment, in any solution which contains an organic/weak acid, inorganic/strong acid and complexing agent/aminopolycarboxylic acid, the halide compounds of the Group VIII transition metals (eg, Ni, Pd, Pt) can form very stable 1:1 complexes with the complexing agent/aminopolycarboxylic acid, and this 1:1 complex can be monitored by UV/VIS. In addition, the UV/VIS signal of any free complexing agent/aminopolycarboxylic acid is not interfered by the other two organic/weak and inorganic/strong acids in the same solution.

Thus, incoming quality control of catalyst bath solution can be performed, and any excess complexing agent/aminopolycarboxylic acid that may be present in the stock solution by supplier mistake, for example, may be accounted for to increase the catalytic solution life. Excess free (or un-complexed) complexing agent/aminopolycarboxylic acid will cause defects in the copper electroless plating process. Additionally, direct via/trench superfilling and defect formations which affect the yields in copper electroless plating process in the semiconductor industry may be improved through effective solution replenishing. Any solution which contains a catalytic metal, an organic/weak acid, an inorganic/strong acid and a complexing agent/aminopolycarboxylic acid in the chemical and analytical industries may be analyzed using the present embodiments.

In one embodiment, the catalyst bath solution may contain halide compounds of the Group VIII transition metal, an organic/weak acid (eg. acetic acid), an inorganic/strong acid (eg. hydrochloric acid, HCl) and a complexing agent/aminopolycarboxylic acid. In one embodiment, the catalyst the solution may be diluted about 4.5 times to about 5.5 times with distilled water. A UV/VIS absorbance may be measured at 384 nm, for example, but the wavelength will depend upon the particular application. Calibration curves of the catalyst metal halide, for example, PdCl2 and the complexing agent/aminopolycarboxylic acid vs. absorbance at 384 nm may be plotted separately.

An unknown catalyst metal halide from the catalyst bath can then be found from the catalyst metal halide calibration curve by fitting its absorbance at the particular wavelength, ex 384 nm. Unknown total complexing agent/aminopolycarboxylic acid (complexed and free) concentration from the catalyst bath can be found from the complexing agent/aminopolycarboxylic acid calibration curve by fitting in its absorbance at the particular wavelength. Since the catalyst metal halide forms a very stable 1:1 complex with the complexing agent/aminopolycarboxylic acid, the complexing agent/aminopolycarboxylic acid concentration roughly equals the concentration of the catalyst metal halide, hence the complexing agent/aminopolycarboxylic acid can be found easily by substracting the complexing agent/aminopolycarboxylic acid concentration from the catalyst metal hydride concentration.

The complexing agent/aminopolycarboxylic acid concentration can be used as an indicator to decide if the catalyst bath will have to be replenished or replaced. The mole ratio between the complexing agent and the catalyst metal halide needs to be roughly 1:1 or the solution may be rejected in the stock solution and the catalyst bath. Referring to FIG. 1c, in one embodiment, a catalytic bath comprising a catalytic metal halide and a complexing agent may be diluted with water to form a stable 1:1 complex of the complexing agent and the catalytic metal halide, and then calibration curves may be plotted at a wavelength using UV/VIS (step 112). At step 114, the absorbance of an unknown catalytic metal and an unknown complexing agent may be measured simultaneously by using UV/VIS and comparing to the calibration curves. The concentration of the unknown complexing agent and the unknown catalytic metal may then be determined.

The electroless plating process 100 may comprise a sensitizer bath 105 (FIG. 1a). The sensitizer bath 105 may comprise group 14 metals in a 2+ oxidation state, such as tin (II) and lead (II). Tin (II) solution can be oxidized very easily to tin (IV) which may lead to serious particle formation. The sensitizer bath 105 of the copper electroless plating process may thus be replenished daily to avoid such oxidation, which is costly and impacts the throughput of the electroless plating process.

Maintaining and optimizing the concentration of the group 14 metals in the 2+ oxidation state along with the acid concentration is critical, otherwise the sensitizer bath and/or the electroless plating bath may form many particles. Copper metal may not plate on a wafer, thus resulting in poor adhesion of the metal on the wafer, decreasing yield. In one embodiment, particle formation may affect direct via/trench superfilling which affect the yields in copper electroless plating process in the semiconductor industry.

Monitoring and/or characterizing the oxidation byproduct (eg. tin (IV) in the sensitizer bath and its related solution of a copper electroless plating process may greatly improve the reproducibly and yield of the electroless plating process. Hence yield on direct via/trench superfilling can be maximized and particle/defect formations can be minimized through replenishing of the plating solution.

The concentration of byproduct (eg. tin (IV), lead (IV)) of the group 14 metals may be monitored/optimized in the sensitizer bath of the copper electroless plating process. The concentration, stability and shelf-life of any solution containing group 14 metals (eg. tin (II), lead (II)) may be optimized by monitoring its oxidation byproducts (eg. tin (IV), lead (IV)). Additionally, an incoming stock solution containing group 14 metals may be analyzed for quality control.

The group 14 metallic solution may be placed in an acidic medium of known concentration, followed by a well adjusted acid-base titration to determine the concentrations of its oxidation byproduct. Any acidic medium may generally be used. In one embodiment, a concentration of about 30 to about 40 percent HCl may be added to the sensitizer bath solution in the copper electroless plating process, which may contain group 14 metallic elements such as tin and lead. In the presence of the concentrated HCl, all of the oxidized group 14 metallic elements eg. tin (IV) and lead (IV), may become soluble metal (IV) chlorides.

Using an autotitration system, the acidified solution may be titrated against a known concentration of standardized NaOH, and may be monitored by an end point titration curve. Both the HCl and the group 14 metal (IV) chlorides react vigorous with NaOH. The reduced forms of the group 14 metallic element in the solution do not react with NaOH or react very slowly. Hence the end-point titration curve will not be affected by the reduced forms. The amount of the oxidized byproduct of the group 14 metallic elements can be found directly by simply performing the following equation: The number of moles of NaOH being used to react with the known amount of HCl and the unknown amount of metallic (IV) chloride)—(number of moles of NaOH being used to react with the known amount of HCl). Monitoring of group (IV) metals contained in any type of solution may performed in this manner.

For example, FIG. 1d depicts moles of HCL vs. time. In one embodiment, when monitoring the tin (IV) formation in the sensitizer bath, the amount of tin (IV) being formed can be found directly by subtracting a SnCl2 and HCl titrate with 0.5M NaOH (mole of HCL) data point on the line 130 from the HCl titrate with 0.5M NaOH Mole of HCL data point on the line 132. In general, the moles of HCL are proportional to the moles of tin 4+. In one embodiment (referring to FIG. 1e), at step 140, a portion of acid may be added to a sensitizer bath comprising at least one of a group 14 reduced metal. At step 142, a concentration of at least one of the oxidized group 14 metal may be determined by acid-base titration.

In another embodiment, the electroless plating process 100 may comprise reducing agents, such as organic aldehydes containing no alpha-hydrogens, such as glyoxylic acid, for example. In one embodiment, the reducing agent may be stored in a stock solution bath and/or container 102 (FIG. 1a). The organic aldehydes may comprise key reducing agents in a metal electroless plating process, such as a copper electroless plating process. In the presence of concentrated bases/alkali chemicals, which may be present in the electroless plating process chemistry, such aldehydes may undergo a self-oxidation and reduction reaction to yield a mixture of an alcohol and a salt of a carboxylic acid.

This reaction is known as the Cannizzaro reaction. In the presence of concentrated bases/alkali (i.e. a basic pH), glyoxylic acid (GA), for example, undergoes the Cannizzaro reaction to yield a mixture of glycolic acid (GC) and oxalic acid (OA) as byproducts according to the following reaction: In concentrated KOH medium, 2(HOCCOOH)(GA)+H2O→HOCH2COOH(GC)+HOOCCOOH(OA). This reaction may lead to unstable reducing agent stock solutions that may need to be replenished or replaced at frequencies that negatively effect fabrication cost and throughput. Other such organic aldehydes containing no alpha-hydrogens may undergo the Cannizaro reaction, and the above reaction is not limited to GA.

In order to monitor the stability of reducing agent stock solutions as well as monitoring the reducing agent in metal electroless plating chemistry, an assay to determine/monitor and optimize the concentrations any organic aldehydes containing no alpha-hydrogens and its self-oxidation and reduction byproducts simultaneously in any solution matrix may be performed.

In one embodiment, by monitoring and optimizing the concentration of the GA, GC and OA, the stability and shelf-life of the organic aldehyde containing no alpha-hydrogens in the stock solution and any related solutions that may be used in IC manufacturing can be monitored.

The concentration/mole ratio between the organic aldehyde containing no alpha-hydrogens 150 and the alkali (for example, KOH, NaOH, TMAH) can be optimized until little to no self-oxidation-and-reduction byproducts are formed. Such optimized stock solutions may comprise shelf-lives of at least nine months. In order to prevent affecting the copper electroless plating bath performance negatively, the highly concentrated glyoxylic acid needs to mix with as much alkali as possible when used as a stock and replenishing solution. In one embodiment, the concentration/mole ratio of GA/KOH can be adjusted and optimized, hence stable stock and replenishing solutions can be achieved with shelf-lives of at least 9 months in some cases. In general, the mole ratio of any organic aldehyde containing no alpha-hydrogens and alkali can be optimized in the manner described herein.

In one embodiment, the mole ratio of GA/KOH, for example, can be determined through the use of a HPLC. In one embodiment, the HPLC may comprise an analytical column with a resin-based packing material coated by an anion exchange latex stationary phase. A conductivity detector with an anion suppressor may be utilized, and an eluent mixture comprising distilled water and KOH may be optimized to achieve the best resolution of the sample mixture of the organic aldehyde containing no alpha-hydrogens and its self-oxidation-and-reduction byproducts glycolic acid GC and oxalic acid OA.

In one embodiment, at step 150, a mole ratio of a concentration of an organic aldehyde containing no alpha hydrogens to a concentration of an alkali in a solution may be monitored using a HPLC (FIG. 1f). At step 160 the mole ratio may be adjusted to optimize the stability of the organic aldehyde containing no alpha hydrogens in the solution. The mole ratio may be adjusted by adding at least one of the organic aldehyde containing no alpha hydrogens and the alkali to the solution.

In some embodiments, the GA can be optimized so that the GA does not need to be replenished for 6 to 9 months, as contrasted with the degradation that may occur in non-optimized baths wherein the GA concentration may decrease in as little as 10-15 minutes in a storage container and/or in electroless plating baths. The pH, concentration of the GA and the base concentration can all be optimized, monitored and optimized according to the particular application.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that certain aspects of microelectronic devices are well known in the art. Therefore, it is appreciated that the Figures provided herein illustrate only portions of an exemplary microelectronic processes and structures that pertain to the practice of the present invention. Thus the present invention is not limited to the process and structures described herein.

What is claimed is:

1. A system comprising:
a UV/VIS to determining one of a stabilizer concentration and a suppressor concentration, wherein the UV/VIS cannot detect the concentration of the other of the stabilizer and the suppressor; and
an ELSD that is coupled to the UV/VIS to determining the other of the stabilizer and suppressor concentration, wherein the ELSD cannot determine the UV/VIS detectable one of the stabilizer and the suppressor.

2. The system of claim 1 comprising wherein the stabilizer comprises a a pyridyl derivative, and the suppressor comprises a PEG derivative.

3. The system of claim 1 further comprising a HPLC coupled to the UV/VIS and the ELSD to separate the stabilizer from the suppressor utilizing an eluent that is optimized for their separation, wherein the HPLC feeds the separated stabilizer and suppressor to the corresponding one of the UV/VIS and ELSD.

4. The system of claim 1 wherein the suppressor and the stabilizer comprise a portion of an electroless plating solution from an electroless plating bath.

5. A method comprising:
an electroless plating process comprising an electroless plating bath, wherein the electroless plating bath comprises a stabilizer and a suppressor;
separating the stabilizer and the suppressor by using a HPLC;
determining the concentration of a UV/VIS detectable one of the stabilizer and the suppressor by using a UV/VIS; and
determining the concentration of an ELSD detectable one of the suppressor and the stabilizer by using an ELSD.

6. The method of claim 5 further comprising wherein the suppressor comprises a PEG derivative, and the sensitizer comprises a pyridyl derivative.

7. The method of claim 5 further comprising wherein the HPLC is coupled with the ELSD and the UV/VIS, and wherein the HPLC feeds the ELSD detectable one of the suppressor and the stabilizer to the ELSD, and feeds the UV/VIS detectable one of the suppressor and the stabilizer to the UV/VIS.

8. The method of claim 5 further comprising wherein the electroless plating process comprises a catalytic bath comprising a catalytic metal halide and a complexing agent;
diluting the catalytic metal halide and the complexing agent with water to form a stable 1:1 complex of the complexing agent and the catalytic metal halide and plotting UV/VIS calibration curves of the complexing agent and the catalytic metal halide; and
measuring the absorbance of an unknown catalytic metal and an unknown complexing agent simultaneously by using UV/VIS and comparing to the calibration curves.

9. The method of claim of 5 further comprising wherein the electroless plating solution further comprises:
a sensitizer bath comprising at least one of a reduced group 14 metal;
adding a portion of acid to the sensitizer bath; and
determining a concentration of at least one of the oxidized group 14 metal by acid-base titration.

10. The method of claim 5 further comprising wherein the electroless plating process further comprises a reducing reagent comprising an organic aldehyde containing no alpha hydrogens;
monitoring a mole ratio of a concentration the organic aldehyde containing no alpha hydrogens to a concentration of an alkali in a solution using a HPLC; and
adjusting the mole ratio to optimize the stability of the organic aldehyde containing no alpha hydrogens in the solution.

11. The method of claim 9 further comprising wherein the portion of acid comprises a concentration of about 30 to about 40 percent HCL.

12. The method of claim 5 wherein the electroless plating process comprises a copper electroless plating process.

13. The method of claim 5 wherein the metallic structures disposed within and on the Damascene structure are not etched by the cleaning mixture.

14. The method of claim 10 further comprising wherein the organic aldehyde containing no alpha hydrogens comprises GA, and the alkali comprises one of KOH, TMAH and NaOH.

15. The method of claim 9 wherein reduced group 14 metal comprise one of lead (II) and tin (II), and the oxidized group 14 metal comprises at least one of lead (IV) and tin (IV).
